(19) United States
(12) Patent Application Publication
(10) Pub. No.: US 2007/0031589 A1
(43) Pub. Date: Feb. 8, 2007

(54) Electron Emission Source of Field Emission Display and Method for making the same

(76) Inventors: Chun-Yen Hsiao, Guanyin Township (TW); Yu-An Li, Guanyin Township (TW); Jin-Lung Tsai, Guanyin Township (TW); Kuei-Wen Cheng, Guanyin Township (TW)

Correspondence Address: HDSL, 4331 STEVENS BATTLE LANE, FAIRFAX, VA, 22033, US

(21) Appl. No.: 11/465,326

(22) Filed: Aug. 17, 2006

Related U.S. Application Data
(62) Division of application No. 10/883,703, filed on Jul. 6, 2004.

(51) Int. Cl. B05D 5/12

(52) U.S. Cl. 427/77; 427/78

(57) ABSTRACT

A method for fabricating an electronic emission source of a field emission display includes to provide a substrate, screen print or lightgraphic etching the laminate to form a cathode electrode layer within the cavities, wherein the surface of the cathode electrode layer fabricates a photoresist by lightgraphy technology, coat a low viscosity carbon nano-tube solution to the surface and depositing it in the cavities, remove the photoresist by vacuum sintering and etching to form an electron emission sources layer having flat surface within the cavities. Comparing with the conventional arts, the present invention is to provide a better flatness, which improves the uniformity of images and brightness. In addition, the present invention enhances the density of Carbon Nano-Tube (“CNT”) and thereby improves the electron density of the electron beams. The structure of the electron emission sources includes a cathode fabricated in a substrate; a cathode electrode layer with cavities formed in the surface of the cathode; and an electron emission sources layer produced by etching, sintering and depositing in the flat surface of the cavities.

This application is a divisional application of U.S. patent application Ser. No. 10/883,703, filed on Jul. 6, 2004.

### BACKGROUND OF THE INVENTION

The present invention relates to an electron emission source of a field emission display and a method for making the same. More particularly, the present invention relates to a structure and the making method of an electron emission source having low threshold field, which possess a better flatness to improve the uniformity of images and brightness, enhance the density of carbon nanotube, and promote the electron density of the electron beams.

Liquid Crystal Display (LCD) and Plasma Display Panel (PDP) are classified to the thin-type display devices and are now most to be used. However, they exist some disadvantages hard to be overcome. Take LCD for example, it is usually lack of enough brightness, large panel view angel, sufficient saturated colors, even sometimes happens glares, low-speed response, and not easy to be manufactured. As to the PDP, the defects include high power consumption, high temperature, and weak image picture etc. In conclusion, these two products practically have some drawbacks. In point of resolution picture, they cannot achieve the standards of conventional Cathode Ray Tube (CRT) display. Under these circumstances, a Filed Emission Display (FED) applied principal theory of CRT is presented. It substitutes many cathode/anode units of grid array for the electron gun and fluoroscope. In addition, FED can achieve the purpose of thinning out and simultaneously keeping the high-resolution picture. In a word, FED can be deemed as the superstar of papery displays. However, although related techniques of FED has been developed over thirty years, merchandising and quantity manufacturing are still choppy until the developments of nanotechnology are disclosed, in which invention of carbon nanotube (CNT) promotes the vigorous improvements. Carbon Nanotube Field Emission Display (CNT-FED) utilizes nanotubes as the electron emission source (cathode) to hold the good-quality picture of CRT display, and possess the merits of power-saving and small volume. Besides, CNT-FED links up the features of low-pass electric field, high-source current density and good stability, thereby becomes a novelty panel display having advantages of low drive voltage, high radiate efficiency, no visual angle problems, and power-saving but with big size and low costs.

FED usually uses cold cathode electron emission source to provide the electron beams in order to replace the hot cathode electron gun of CRT display. When FED is supplied with the electric field, the cold cathode electron emission source faces an anode layer coated with fluorescent and sends out the electron beams to strike and shine. Therefore, density of CNT regarded as the electron emission source directly affects the electron density of the electron beams. It is also important to provide CNT with a flat surface of the cathode layer to be coated or integrated thereon. If the surface of cathode layer is not flat enough, the produced electron emission source following becomes uneven, however the uniformity of electron emission source affects the evenness of image and brightness.

Using CNT as the electron emission source of FED has excellent emission of electron beams, but coating small and numerous CNT to the cathode layer is still one problem need to be improved. Manufacture of conventional CNT electron emission source commonly utilizes methods including but not limited to Chemical Vapor Deposition (CVD), screen print, photolithography or electrophoresis. The manufacturing process still exists many problems and difficulties to be solved.

In the known techniques of producing CNT electron emission source, Milne et al uses a single photomask and self-alignment to fabricate a micro field emission cathode by CVD. This technique makes CNT and pinhole of gate can be collinear.

The process of producing micro field emission layer includes lithographying, photoresisting, and etching the layered structures that are composed of silicone, metal, silicon dioxide, and polysilicon to form cavities having 2 microns in diameter; and depositing titanium nitride (TiN) and nickel from the outside deposited nickel in the cavities, wherein TiN can prevent nickel from diffusing into metal layer when under the high temperature for deposition of micro field emission layer, and the nickel is the catalyzer. Then, remove the photoresist and remain the catalyzer in the cavities. Finally, the CNT in high temperature within the micro cavities is formed by CVD by supplying suitable gas, such as acetylene, ammonia gas and etc. The range of deopsition is about 1 micron in diameter. When the deposition is completed, each micro cavity has about over ten CNTs, wherein eachCNT is about 10-50 microns in diameter and about 0.4 micron in length.

Such production of thin film can obtain the electron emission source with high electron density and good uniformity, but the threshold field will be a little higher than average, it is about over 5V/um. In addition, this fabrication can only apply to silicon wafer and even cost a lot.

Another method uses coating by screen print or spraying to make the CNT electron emission source. That is, CNT cooperates coating arbitrarily and disorderly arranged onto the surface of cathode layer by way of screen print or spraying. Sintering the CNT to stick to the cathode layer, the structure of the CNT electron emission source is completed. In this kind of production, flat surface of cathode layer should be much critical because the flatness affects the evenness of produced CNT electron emission sources and uniformity of electron emission. Therefore, high requisition for flat surface of cathode layer will certainly lead to high costs and a more complex process.

Conventional production method for electron emission source utilizes screen print. Limiting by the screen structure, especially in thick-film screen print, the flatness of surface becomes relatively poor, and the flatness of produced electric emission source will be poor. The diversity of surface can be over 10 um in the process of production. Furthermore, in order to integrate CNT to the surface of cathode layer, large amount of adherent powders such as glass powders are added into the CNT coating. In this way, the density of CNT deposited within the coating becomes lower, and thereby the low density of produced CNT electron emission source make the electron emission density reduced.

### BRIEF SUMMARY OF THE INVENTION

The present invention is to provide a structure of an electron emission source for FED and a method of making the same. It uses a substrate to be a cathode and screen-printing or lithography etching the laminate to form a base, wherein the base includes a holed cathode electrode layer. Making a photoresist layer on the surface of the cathode electrode by a lithography process; coating carbon nanotube (CNT) solution with low viscosity on the photoresist layer to deposit in the hole; vacuum sintering and etching are applied to remove the photoresist layer and finally an electron emission source with a uniform surface is finished.

The present invention is further to provide a structure of an electron emission source and a making method thereof. CNT solution with low viscosity is deposited in the cavities of screen printed cathode electrode layer. Even the evenness of the cathode electrode layer and cavity is uneven, the deposition of forming a flat electron emission source layer will not be influenced. In this way, the surface flatness of the cathode electrode layer no longer affects the uniformity of surface of the electron emission source.

Still the present invention is to provide a structure of the electron emission source and the making method thereof. CNT solution with low viscosity is deposited to the cavities of cathode electrode layer and sintered to obtain a CNT deposited cathode electrode that is increased in density.

Still the present invention is to provide a structure of the electron emission source and the making method thereof. Uniformity and density of planted CNT is increased. The threshold field can be lowered down to 1.8V/μm with current of 10 μA/cm², wherein when the electric field is 2.5 V/μm, the current of 10 mA/cm² will be brought.

Accordingly the cathode electrode layer of the present invention not only can be finished after screen printing the substrate, it also can be deposited the CNT solution with low viscosity within the cavities, and after the process of sintering, an electron emission source layer with flat surface can be obtained.

In one preferred embodiment of the present invention, the steps of the method for fabricating an electron emission source for a field emission display includes to provide a substrate to be the cathode; proceed to screen printing or etching to form a cathode electrode layer located to the substrate and thereby form a cavity; fill the CNT solution with low viscosity into the cavity and form an electron emission source layer with flat surface. Finally, the junction of CNT solution with low viscosity can be finished by vacuum sintering.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The above objects and advantages of the present invention will be become more apparent by describing in detail exemplary embodiments thereof with reference to the attached drawings in which:

FIG. 1 shows a sectional view of one preferred embodiment according to the present invention.

FIG. 2 shows a process of one preferred embodiment according to the present invention.

FIG. 3 shows a process of another embodiment according to the present invention.

FIG. 4 shows a process of still another preferred embodiment according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

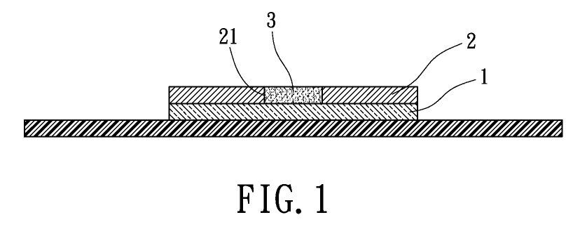

The present invention is to provide a structure of an electron emission source and the method of making same. It is to obtain an electron emission sources layer having improved evenness and density of a carbon nanotube (CNT) to enhance the uniformity of images and brightness, and promote the quality of electron density of electron beams in a field emission display. Referring to FIG. 1, a cross-sectional view of one preferred embodiment of the present invention is shown. The structure of electron emission source in FIG. 1 includes a substrate 1, a cathode electrode layer 2 with a plurality of cavities 21 made by screen printing or etching formed on the substrate 1 and an electron emission source layer 3 having flat surface formed by filling the low-viscosity CNT solution into the cavities.

Addition of the CNT solution into cathode electrode layer 2 and filled in the cavities 21 can be done by lithography to fabricate a photoresist layer onto the surface of cathode electrode layer 2, and thereby provide a low-viscosity CNT solution coated to the photoresist layer and the cavities 21. When vacuum sintering is finished, remove the photoresist by etching, and then a CNT layer having flat surface can be formed within the cavities 21. The CNT layer can be deemed an electron emission source layer 3.

In one embodiment of the present invention, the substrate 1 is transparent, while in other embodiments it can be a glass laminate. The cathode electrode layer 2 can be made selected from materials including Ag, Cr, ITO, etc.

In one preferred embodiment of the present invention, the thickness of cathode electrode layer 2 is about 0.1 to 10 um. The depth of the cavities 21 formed in the cathode electrode layer 2 is about 5 to 10 um. The maximum of length of the CNT is preferably less than 1 um.

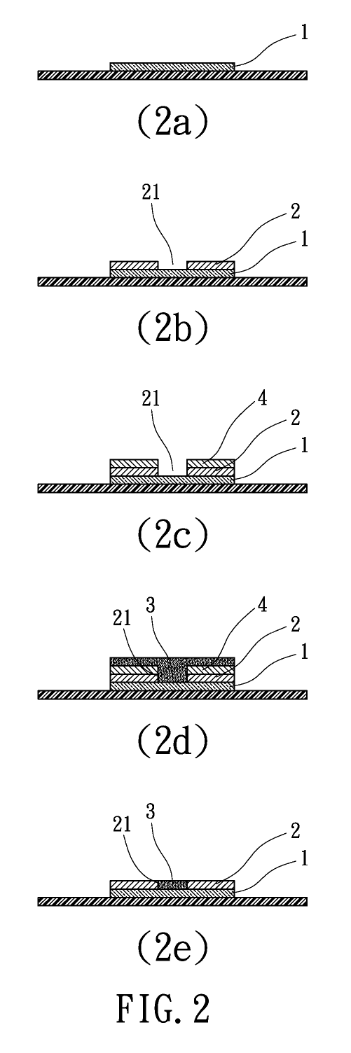

A structure made according to present invention can be obtained. Following processes of the preferred embodiments are explained in detail with drawings of the process of structure of electron emission sources. FIG. 2A to 2E are the fabricating processes of a structure of electron emission source of the first embodiment according to the present invention. Procedures of making the structure of electron emission source includes:
(a) providing a substrate 1 as shown in FIG. 2A.
(b) using photolithography techniques of screen printing to fabricate conductive metal on the surface of the substrate 1 and form a cathode electrode layer 2. At the same time, the surface of the cathode electrode layer are formed a plurality of cavities 21, as shown in FIG. 2B;
(c) forming a photoresist layer 4 on the surface of the cathode electrode layer 2 by way of lithography, as shown in FIG. 2C;
(d) coating the CNT solution with low-viscosity deposited on the surface of the photoresist layer 4 so that the solution is filled into the cavities 21, as shown in FIG. 2D; and
(e) using vacuum sintering to remove the extra CNT solution, removing the photoresist layer 4 and the CNT solution existing in the surface by way of etching, and then integrate the resulted CNT layer with high density within the cavities 21 to form the an electron emission source layer 3, as shown in FIG. 2E.

In one preferred embodiment of the present invention, the thickness of membrane produced on the cathode electrode layer 2 of the substrate 1 is about 0.1 to 10 um. The depth of each cavity formed by cathode electrode layer 2 is about 5 to 10 um. Thickness of the photoresist layer 4 produced on the surface of the cathode electrode layer 2 is about 1 to 2 um. In addition, the length of CNT deposited to the low-viscosity CNT solution is preferably less than 1 um.

According to the process of this embodiment, the depth surrounding to the cavities 21 is at least more than about 5 um. Furthermore, in the process of one embodiment, CNT can be deposited within the cavities 21, cooperated with the deposition with low-viscosity solution to fill into the cavities 21, and then an uniform surface of the deposition can be obtained. In case the surfaces of cathode electrode layer 2 and cavities 21 are uneven, a flat electron emission source layer still can be achieved by depositing the CNT solution within the cavities 21.

The electron emission source according to the present invention provides a improved flat surface of the CNT, a more uniform electron beams, and thereby enhances the evenness of images and brightness.

Accordingly, in one embodiment of the present invention, CNT has a large aspect ratio, so the low-viscosity CNT solution will deposit to be formed a high density CNT, and the high-density CNT will be bonded with each other and then integrated within the cavities 21. Therefore, comparing with the conventional prior arts, the CNT coating used in the present invention is not necessary to add large amount of solid powders, such as glass powders to stick the CNT. Only by simple vacuum sintering can remove the extra CNT solution. The CNT density deposited within the cavities 21 will be enhanced due to the unnecessary step of adding solid powders, and thereby improves the electron density of electron beams.

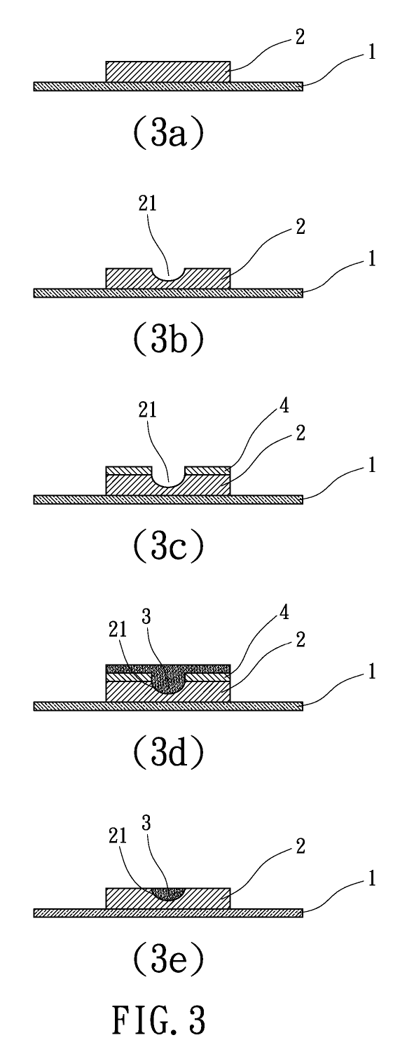

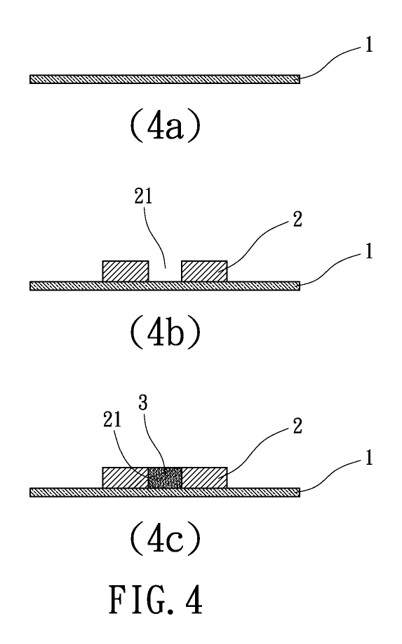

Excepting to the process describing in FIGS. 3A to 3E, the structure of electron emission source of the present invention can be carried out by another preferred embodiment. Process of the second preferred embodiment includes to provide a substrate 1, fabricate the cathode electrode layer 2, form the cavities 21, make the photoresist layer 4, manufacture the CNT and remove the photoresist layer 4. Using photoresist dielectric coating to fabricate the cathode electrode layer 2, further make the cavities 21 located on the surface of the cathode electrode layer 2, proceed to make the photoresist layer in order, manufacture the CNT, remove the photoresist layer 4, and then the structure of electron emission layer is completed. FIGS. 3A to 3E explain the process of the production.
(a) providing a substrate 1, as shown in FIG. 3A;
(b) using photoresist dielectric coating of screen printing to fabricate the cathode electrode layer 2 on the substrate 1 and cooperating the gray level photomask with exposure developingt to fabricate cavities 21 onto the surface of the cathode electrode layer 2, as shown in FIG. 3B. The photoresist dielectric coating is preferably selected from the photoresist silver coating;
(c) fabricating a photoresist protective layer 4 on the surface of the cathode electrode layer 2 by lithography, as shown in FIG. 3;
(d) coating the low-viscosity CNT solution onto the surface of the photoresist layer 4, filling the solution into cavities 21 and then depositing it, as shown in FIG. 4; and
(e) proceeding to bonding, such as vacuum sintering to remove the extra solution from the CNT solution, removing the photoresist layer 4 and CNT solution existing in the surface by way of etching, and then integrate the resulted high-density CNT within the cavities 21 to form the electron emission source layer 3, as shown in FIG. 3E.

According to the process of the second embodiment, a structure of electron emission source can be obtained as the first embodiment provided. In the uniformity of the electron emission sources and density of CNT, both have excellent expression in enhancing the evenness of images and brightness as well as the improvement of electron density of the electron beams.

Referring to FIG. 4A to 4C, it shows the third preferred embodiment of the present invention. The process of the third embodiment comprises to provide a substrate 1, fabricate the cathode electrode layer with cavities, and manufacture a CNT. That is, filling the low-viscosity CNT solution into cavities by sintering to complete the structure of the electron emission sources. Process of the third preferred embodiment comprises:
(a) providing a substrate 1 as shown in FIG. 4A, wherein the substrate is transparent and/or can be made of glass materials;
(b) using photolithography techniques to fabricate conductive metal on the surface of the substrate 1 and form a cathode electrode layer 2. At the same time, the surface of the cathode electrode layer forms cavities 21, as shown in FIG. 4B; and
(c) filling the low-viscosity CNT solution into cavities located to the surface of the cathode electrode layer 2 and depositing it, as shown in FIG. 4C; and
(d) bonding, such as vacuum sintering to remove the extra solution from the CNT solution, and thereby the high-density CNT solution can be integrated to the cavities 21 and formed the electron emission sources layer 3.

In the structure of the electron emission source of above-mentioned embodiments according to the present invention, the evenness of the electron emission source and density of the CNT can be significantly improved. When the electron beams of the electron emission sources are during operation, the threshold field can be lowered down to 1.8V/μm with current of 10 μA/cm², and when the electric field is 2.5 V/μm, the current of 10 mA/cm² will be brought.

While the present invention of a structure of electron emission source and a method of making same has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of fabricating an electron emission source of an emission field display, comprising:
providing a substrate;
forming a cathode electrode layer with a plurality of cavities on the substrate;
forming a photoresist layer on the surface of the cathode layer without forming in the cavities;
coating a carbon nanotube (CNT) layer with low-viscosity on the photoresist layer to fill within the cavities;
removing the CNT layer from the surface of the photoresist layer without removing from the cavities;
vacuum sintering the CNT layer filled in the cavities.

2. The method of claim 1, wherein the cavities are pattterned in the cathode electrode layer by screen printing.

3. The method of claim 1, wherein a depth of the cavities is defined by a thickness of the cathode electrode layer and the photoresist layer fabricated so that a uniform surface of CNT layer within the cavities can be obtained.

4. The method of claim 1, wherein the CNT layer is a high-density carbon nanotube deposition solution without solid powder addition.

5. A method of fabricating an electron emission source layer, comprising:
providing a substrate;
screen printing a cathode electrode layer with a plurality of cavities on the substrate;
forming a photoresist layer on the cathode layer;
coating a carbon nanotube (CNT) layer with low-viscosity on the photoresist layer to fill within the cavities;
vacuum sintering the CNT layer deposited in the cavities to form the flat electron emission source layer.

6. The method of claim 5, wherein a depth of the cavities is defined by a thickness of the cathode electrode layer and the photoresist layer so that a uniform surface of CNT layer within the cavities can be obtained.

7. The method of claim 5, wherein the CNT layer is a high-density carbon nanotube deposition solution without solid powder addition.
